(19) United States
(12) Patent Application Publication
(10) Pub. No.: US 2016/0068196 A1
(43) Pub. Date: Mar. 10, 2016

(54) VEHICLE LOWER SECTION STRUCTURE

(71) Applicant: Toyota Jidosha Kabushiki Kaisha, Toyota-shi (JP)

(72) Inventor: Koji SAEKI, Okazaki-shi (JP)

(73) Assignee: Toyota Jidosha Kabushiki Kaisha, Toyota-shi (JP)

(21) Appl. No.: 14/829,776

(22) Filed: Aug. 19, 2015

(30) Foreign Application Priority Data
Sep. 4, 2014 (JP) 2014-180273

(51) Int. Cl. B62D 21/15; B62D 25/20

(52) U.S. Cl. CPC B62D 21/157; B62D 25/2072

(57) ABSTRACT

There is provide a vehicle lower section structure, the structure including a rocker disposed at a vehicle width direction outside of a floor panel, and extending in a vehicle front-rear direction, a floor cross member disposed above the floor panel, and extending in a vehicle width direction, and a sub-rocker that is disposed above the floor panel between the rocker and the floor cross member, that couples the rocker to a vehicle width direction outside end portion of the floor cross member, and that is formed with a longer length than the floor cross member in the vehicle front-rear direction.

### CROSS-REFERENCE TO RELATED APPLICATION

This application claims priority under 35 USC 119 from Japanese Patent application No. 2014-180273 filed on Sep. 4, 2014, the disclosure of which is incorporated by reference herein.

### BACKGROUND

1. Technical Field

The present disclosure relates to a vehicle lower section structure.

2. Related Art

As a vehicle lower section structure provided with a rocker extending in a vehicle front-rear direction and a floor cross member extending in a vehicle width direction, Japanese Patent Application Laid-Open (JP-A) No. 2014-125194 describes a structure in which a lower end portion of a side sill (rocker) is coupled to a lower face of a floor panel by a belt shaped plate member. When collision load is input to a center pillar in a side-on collision, tensile force acts on the plate member, thereby suppressing moment acting in the side sill. JP-A No. 2014-125097 describes a configuration in which a gusset is provided to couple together a rocker and a floor panel.

Although the techniques of JP-A No. 2014-125194 and JP-A No. 2014-125097 suppress moment acting on the rocker in a side-on collision, there is room for further improvement in effectively suppressing collapse of the rocker toward the vehicle cabin inside.

### SUMMARY

In consideration of the above circumstances, the present disclosure provides a vehicle lower section structure capable of effectively suppressing collapse of a rocker toward the vehicle cabin inside in a side-on collision.

A first aspect of the present disclosure is a vehicle lower section structure including a rocker disposed at a vehicle width direction outside of a floor panel, and extending in a vehicle front-rear direction, a floor cross member disposed above the floor panel, and extending in a vehicle width direction, and a sub-rocker that is disposed above the floor panel between the rocker and the floor cross member, that couples the rocker to a vehicle width direction outside end portion of the floor cross member, and that is formed with a longer length than the floor cross member in the vehicle front-rear direction.

In the vehicle lower section structure of the first aspect, the rocker extends in the vehicle front-rear direction at the vehicle width direction outside of the floor panel. The floor cross member extends in the vehicle width direction above the floor panel. The sub-rocker is disposed above the floor panel between the rocker and the floor cross member, and the sub-rocker couples the rocker to the vehicle width direction outside end portion of the floor cross member. This thereby enables collision load to be transmitted to the floor cross member through the sub-rocker when collision load is input to the rocker through a center pillar or the like in a side-on collision of the vehicle.

The sub-rocker is formed longer than the floor cross member in the vehicle front-rear direction. This thereby enables the collision load acting on the rocker to be borne over a wider region in the vehicle front-rear direction than in a configuration in which the floor cross member is joined directly to the rocker. This thereby enables moment acting in the rocker to be effectively suppressed.

A second aspect of the present disclosure is the vehicle lower section structure of the first aspect, wherein an under reinforcement that extends in the vehicle front-rear direction, that includes flanges on both vehicle width direction sides, and that has a hat shaped cross-section open toward the vehicle upper side, is joined to a vehicle lower side face of the floor panel, and the sub-rocker is joined to the floor panel at a position at which the flange on the vehicle width direction outside of the under reinforcement is joined to the floor panel.

In the vehicle lower section structure of the second aspect, collision load transmitted from the rocker to the sub-rocker in a side-on collision is distributed to the under reinforcement. This thereby enables concentration of collision load in the floor cross member to be suppressed.

A third aspect of the present disclosure is the vehicle lower section structure of the second aspect, wherein the under reinforcement is coupled to a vehicle lower side end portion of the rocker by a coupling member.

In the vehicle lower section structure of the third aspect, the rocker attempts to rotate with respect to the floor panel when moment due to collision load acts in the rocker in a side-on collision. However, due to transmitting collision load from the rocker, through the sub-rocker, and into the under reinforcement, the flange on the vehicle width direction outside of the under reinforcement is pushed, and moment in the under reinforcement acts toward the opposite direction to the rocker. Namely, the under reinforcement attempts to rotate toward the opposite direction to the rocker with respect to the floor panel. Since the vehicle lower side of the rocker and the under reinforcement are coupled together by the coupling member, tensile force acts in the coupling member, thereby enabling rotation of the rocker and the under reinforcement to be suppressed.

A fourth aspect of the present disclosure is the vehicle lower section structure of any one of the first aspect to the third aspect, wherein a tunnel section extends along the vehicle front-rear direction at a vehicle width direction central portion of the floor panel, and a sub-tunnel section that couples the tunnel section to a vehicle width direction inside end portion of the floor cross member, and that is formed with a longer length than the floor cross member in the vehicle front-rear direction, is provided above the floor panel at the vehicle width direction outside of the tunnel section.

In the vehicle lower section structure according to the fourth aspect of the present disclosure, collision load input to the floor cross member through the sub-rocker in a side-on collision is transmitted through the sub-tunnel section to the tunnel section. The sub-tunnel section is formed longer than the floor cross member in the vehicle front-rear direction, thereby enabling collision load to be distributed over a wide range in the vehicle front-rear direction, and enabling concentration of collision load in a join portion between the floor cross member and the tunnel section to be suppressed.

As described above, the vehicle lower section structure of the first aspect enables the rocker to be effectively suppressed from collapsing toward the vehicle cabin inside in a side-on collision.

The vehicle lower section structure according to the second aspect enables effective distribution of stress transmitted to the floor cross member, thereby enabling the deformation amount of the floor cross member to be suppressed.

The vehicle lower section structure of the third aspect enables collapse of the rocker toward the vehicle cabin inside, and collapse of the under reinforcement, to be effectively suppressed.

The vehicle lower section structure of the fourth aspect enables the floor cross member to be suppressed from snapping at a join portion between the floor cross member and the tunnel section in a side-on collision.

### BRIEF DESCRIPTION OF THE DRAWINGS

Exemplary embodiments of the present disclosure will be described in detail based in the following figures, wherein:

FIG. 1 is a schematic perspective view illustrating a vehicle lower section structure according to a first exemplary embodiment of the present disclosure, as viewed from the vehicle rear side;

FIG. 2 is a plan view illustrating a vehicle lower section structure according to the first exemplary embodiment of the present disclosure;

FIG. 3 is an enlarged cross-section taken along line 3-3 in FIG. 2;

FIG. 4 is an enlarged cross-section illustrating relevant portions in the cross-section plane shown in FIG. 3; and

FIG. 5 is a drawing corresponding to FIG. 4, illustrating relevant portions of a vehicle lower section structure according to a second exemplary embodiment of the present disclosure.

### DETAILED DESCRIPTION

### First Exemplary Embodiment

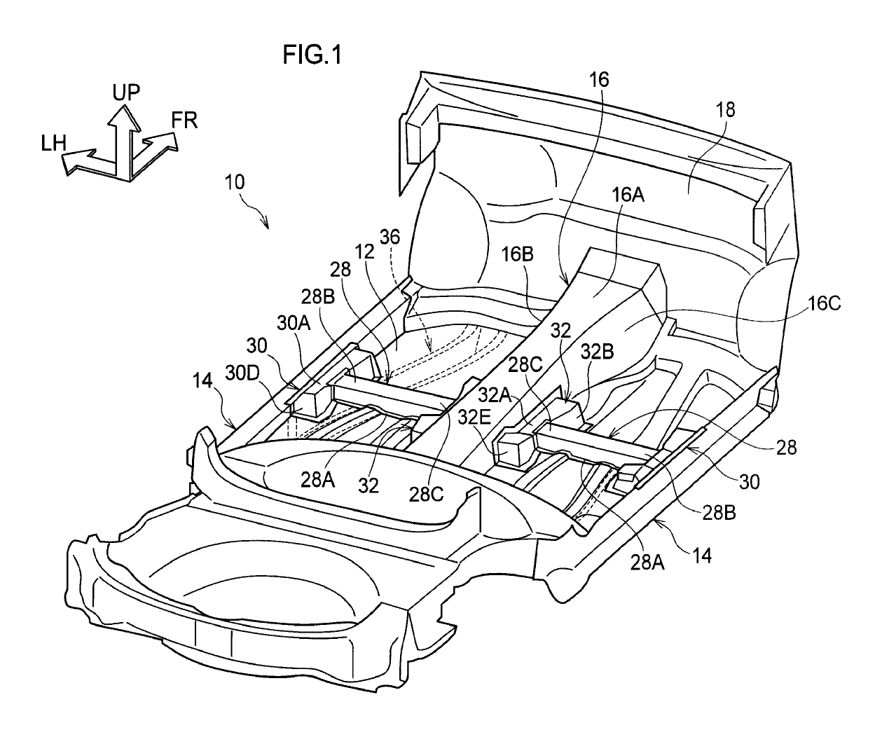

Explanation follows regarding a vehicle lower section structure according to a first exemplary embodiment of the present disclosure, with reference to FIG. 1 to FIG. 4. In each of the drawings, the arrow FR indicates the vehicle front side, the arrow UP indicates the vehicle upper side, and the arrow LH indicates the vehicle left side in the vehicle width direction, as appropriate. Unless specifically indicated otherwise, reference in the following explanation to the front-rear, vertical, and left-right directions refer to the front and rear in the vehicle front-rear direction, up and down in the vehicle vertical direction, and left and right when facing in the direction of travel.

### Overall Configuration of Vehicle Lower Section Structure

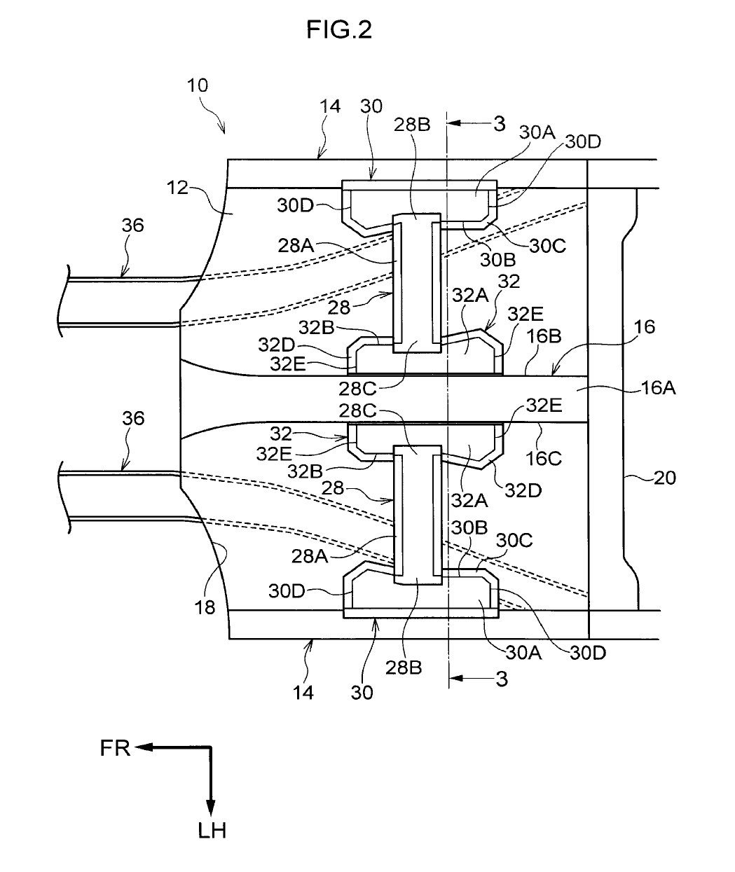

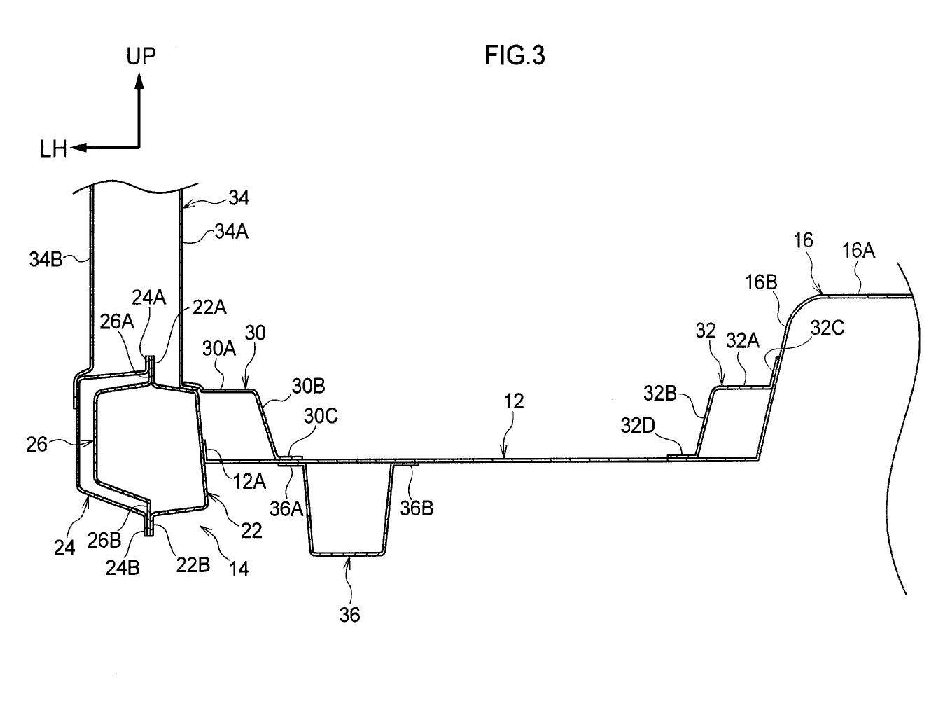

As illustrated in FIG. 1 and FIG. 2, a floor panel 12 configuring a floor section of a vehicle cabin is disposed in a vehicle lower section 10 of a vehicle applied with a vehicle lower section structure of the present exemplary embodiment. The floor panel 12 is a plate member with a substantially rectangular shape in plan view, and configures a bottom face of the vehicle. A tunnel section 16 formed by bending the floor panel 12 upward is provided at a vehicle width direction central portion of the floor panel 12. Vehicle width direction outside end portions 12A of the floor panel 12 are bent toward the top of the vehicle, and joined by spot welding or the like to rocker inner panels 22 of rockers 14, described later (see FIG. 3).

As illustrated in FIG. 1, the tunnel section 16 extends in the vehicle front-rear direction, and has a substantially U-shaped cross-section profile open toward the vehicle lower side as taken vertically along the vehicle width direction. The tunnel section 16 is configured including a left side face 16B on the vehicle left side, a right side face 16C on the vehicle right side, and an upper face 16A connecting together upper end portions of the left side face 16B and the right side face 16C. A vehicle front side end portion of the tunnel section 16 is joined to a dash panel 18 formed with a broad width. Moreover, a vehicle rear side end portion of the tunnel section 16 is joined to a rear cross member 20 that is disposed at a vehicle rear side end portion of the floor panel 12 and that extends in the vehicle width direction (see FIG. 2).

A pair of left and right rockers 14 are provided at the vehicle width direction outsides of the floor panel 12. The pair of rockers 14 are disposed substantially parallel to each other, and extend in the vehicle front-rear direction. As illustrated in FIG. 3, each of the rockers 14 is configured with a closed cross-section profile, and includes a rocker inner panel 22 disposed at the vehicle width direction inside, a rocker outer panel 24 disposed at the vehicle width direction outside, and rocker outer reinforcement 26 disposed between the rocker inner panel 22 and the rocker outer panel 24.

The rocker inner panel 22 has a substantially hat shaped cross-section profile open toward the vehicle width direction outside as taken vertically along the vehicle width direction. An inner side upper flange 22A extends out from an upper end portion of the rocker inner panel 22 toward the top of the vehicle. An inner side lower flange 22B extends out from a lower end portion of the rocker inner panel 22 toward the bottom of the vehicle.

The rocker outer panel 24 is disposed facing the rocker inner panel 22 in the vehicle width direction, and has a substantially hat shaped cross-section profile open toward the vehicle width direction inside as taken vertically along the vehicle width direction. An outer side upper flange 24A extends out from an upper end portion of the rocker outer panel 24 toward the top of the vehicle, and an outer side lower flange 24B extends out from a lower end portion of the rocker outer panel 24 toward the bottom of the vehicle.

The rocker outer reinforcement 26 has a substantially hat shaped cross-section profile open toward the vehicle width direction inside as taken vertically along the vehicle width direction. An upper flange 26A extends out from an upper end portion of the rocker outer reinforcement 26 toward the top of the vehicle. The upper flange 26A is interposed between the inner side upper flange 22A and the outer side upper flange 24A, and is joined to the inner side upper flange 22A and the outer side upper flange 24A by spot welding or the like. A lower flange 26B extends out from a lower end portion of the rocker outer reinforcement 26 toward the bottom of the vehicle. The lower flange 26B is interposed between the inner side lower flange 22B and the outer side lower flange 24B, and is joined to the inner side lower flange 22B and the outer side lower flange 24B by spot welding or the like.

A center pillar 34 extending along the vehicle vertical direction is disposed above each of the rockers 14. The center pillar 34 is configured including a pillar inner panel 34A disposed on the vehicle width direction inside, and a pillar outer panel 34B disposed on the vehicle width direction outside. A lower end portion of the pillar inner panel 34A bends toward the vehicle width direction inside, and is joined to an upper portion of the rocker inner panel 22 by spot welding or the like. A lower end portion of the pillar outer panel 34B bends toward the vehicle width direction outside before extending further toward the bottom of the vehicle, and is joined to an upper portion of the rocker outer panel 24 by spot welding or the like.

As illustrated in FIG. 1 and FIG. 2, a pair of left and right floor cross members 28 are disposed above the floor panel 12 between the pair of rockers 14. The floor cross members 28 extend in the vehicle width direction, and are provided on the vehicle right side and the vehicle left side of the vehicle lower section 10 respectively, on both sides of the tunnel section 16. Each of the floor cross members 28 is formed with a substantially hat shaped cross-section profile open toward the vehicle lower side as taken vertically along the vehicle front-rear direction, and flanges 28A extend out toward the vehicle front and vehicle rear from lower end portions of each floor cross member 28. The flanges 28A are joined to the floor panel 12 by spot welding or the like.

A pair of left and right sub-rockers 30 are disposed above the floor panel 12, between the rockers 14 and the floor cross members 28. The sub-rockers 30 couple an outside end portion 28B on the vehicle width direction outside of each floor cross member 28 to the respective rocker 14. A pair of left and right sub-tunnel sections 32 are provided above the floor panel 12 at the vehicle width direction outsides of the tunnel section 16. The sub-tunnel sections 32 couple an inside end portion 28C on the vehicle width direction inside of each of the floor cross members 28 to the tunnel section 16.

Each of the sub-rockers 30 is formed in a substantially rectangular shape, with its length direction along the vehicle front-rear direction in plan view. As illustrated in FIG. 3, the sub-rocker 30 on the vehicle left side includes an upper wall 30A extending out from an upper end portion of the rocker 14 toward the vehicle width direction inside, and an upright wall 30B extending out from a vehicle width direction inside end portion of the upper wall 30A toward the bottom of the vehicle. A vehicle width direction outside end portion of the upper wall 30A is joined to the upper end portion of the rocker 14 by spot welding or the like, with the pillar inner panel 34A interposed therebetween.

A flange 30C extends out along the floor panel 12 toward the vehicle width direction inside at a lower end portion of the upright wall 30B. The flange 30C is joined to a vehicle upper side face (upper face) of the floor panel 12 by spot welding or the like. The sub-rocker 30, the floor panel 12, and the rocker inner panel 22 accordingly configure a closed cross-section.

As illustrated in FIG. 1 and FIG. 2, side walls 30D are provided on both vehicle front-rear direction sides of the sub-rocker 30. Lower end portions of the side walls 30D are joined to the floor panel 12 by flanges that are continuous to the flange 30C. Vehicle width direction outside end portions of the side walls 30D are joined to the rocker 14.

As illustrated in FIG. 2, the outside end portion 28B of the floor cross member 28 is joined to a vehicle front-rear direction central portion of the sub-rocker 30. More specifically, the outside end portion 28B includes an upper side flange extending out following an upper face toward the vehicle width direction outside. The upper side flange is joined to the upper wall 30A of the sub-rocker 30 by spot welding or the like. As illustrated in FIG. 1, respective front and rear flanges extend out from the outside end portion 28B in the vehicle front-rear direction, and are joined to the upright wall 30B of the sub-rocker 30 by spot welding or the like. This enables load input to the sub-rocker 30 to be effectively transmitted to the floor cross member 28. Further, setting the upper face of the floor cross member 28 at substantially the same height as the height of the upper wall 30A of the sub-rocker 30 enables a continuous ridge line to be formed around the upper sides of the sub-rocker 30 and the floor cross member 28, thereby enabling improved load transmission efficiency. The length of the sub-rocker 30 in the vehicle front-rear direction is formed longer than the length (width) of the floor cross member 28 in the vehicle front-rear direction. Note that the sub-rocker 30 on the vehicle right side is configured by a structure with left-right symmetry to the sub-rocker 30 on the vehicle left side, and so explanation thereof is omitted.

Each sub-tunnel section 32, to which the inside end portion 28C of the respective floor cross member 28 is joined, is formed in a substantially rectangular shape in plan view, with its length direction along the vehicle front-rear direction, similarly to the sub-rocker 30. As illustrated in FIG. 3, the sub-tunnel section 32 on the vehicle left side includes an upper wall 32A extending out from a vehicle vertical direction central portion of the left side face 16B of the tunnel section 16 toward the vehicle width direction outside, and an upright wall 32B extending out from a vehicle width direction outside end portion of the upper wall 32A toward the bottom of the vehicle. A flange 32C extends out toward the top of the vehicle along the left side face 16B at a vehicle width direction inside end portion of the upper wall 32A, and the flange 32C is joined to the left side face 16B by spot welding or the like.

A flange 32D extends out toward the vehicle width direction outside along the floor panel 12 at a lower end portion of the upright wall 32B. The flange 32D is joined to the vehicle upper side face (upper face) of the floor panel 12 by spot welding or the like. The sub-tunnel section 32, the floor panel 12, and the left side face 16B of the tunnel section 16 accordingly configure a closed cross-section.

As illustrated in FIG. 1 and FIG. 2, side walls 32E are provided on both vehicle front-rear direction sides of the sub-rocker 30. Lower end portions of the side walls 32E are joined to the floor panel 12 by flanges that are continuous to the flange 32D. Vehicle width direction inside end portions of the side walls 32E are joined to the left side face 16B of the tunnel section 16.

As illustrated in FIG. 2, the inside end portion 28C on the vehicle width direction inside of the floor cross member 28 is joined to a vehicle front-rear direction central portion of the sub-tunnel section 32. The length of the sub-tunnel section 32 in the vehicle front-rear direction is formed substantially the same as the length of the sub-rocker 30, and is formed longer than the length (width) of the floor cross member 28 in the vehicle front-rear direction. Note that the sub-tunnel section 32 on the vehicle right side is similar in structure to the sub-tunnel section 32 on the vehicle left side.

A pair of left and right of under reinforcements 36 are provided at the vehicle lower side of the floor panel 12. The under reinforcements 36 are provided on the vehicle right side and the vehicle left side of the tunnel section 16 respectively, and extend along the vehicle front-rear direction. At the vehicle front side of the dash panel 18, the under reinforcements 36 extend along the vehicle front-rear direction in a substantially straight line in plan view, and, at the vehicle rear side of the dash panel 18, the under reinforcements 36 are disposed at an angle toward the vehicle width direction outside on progression from the vehicle front toward the vehicle rear in plan view.

As illustrated in FIG. 3, each under reinforcement 36 has a substantially hat shaped cross-section profile open toward the vehicle upper side as taken vertically along the vehicle width direction, and flanges are provided on both vehicle width direction sides of the under reinforcement 36. More specifically, an outside flange 36A extends out along the floor panel 12 toward the vehicle width direction outside from an upper end portion on the vehicle width direction outside of the under reinforcement 36. An inside flange 36B extends out along the floor panel 12 toward the vehicle width direction inside from an upper end portion on the vehicle width direction inside of the under reinforcement 36. The under reinforcement 36 and the floor panel 12 thus configure a closed cross-section.

The outside flange 36A and the inside flange 36B are overlaid with a vehicle lower side face (lower face) of the floor panel 12, and welded thereto by spot welding or the like. The flange 30C of the sub-rocker 30 is joined to the floor panel 12 at the position where the outside flange 36A of the under reinforcement 36 is joined to the floor panel 12. In the present exemplary embodiment, the three layers of the flange 30C, the floor panel 12, and the outside flange 36A are all joined together with each other by spot welding or the like. The “position where the outside flange 36A of the under reinforcement 36 is joined to the floor panel 12” referred to here refers to at least part of a portion where the outside flange 36A and the floor panel 12 are in contact with each other. It is accordingly sufficient for the flange 30C of the sub-rocker 30 to overlap at least partially with the outside flange 36A of the under reinforcement 36 in plan view of the vehicle.

### Operation

Next, explanation follows regarding operation of the vehicle lower section structure of the present exemplary embodiment. As an example, explanation follows regarding a case in which collision load is input from the vehicle left side; however similar results can be obtained when collision load is input from the vehicle right side.

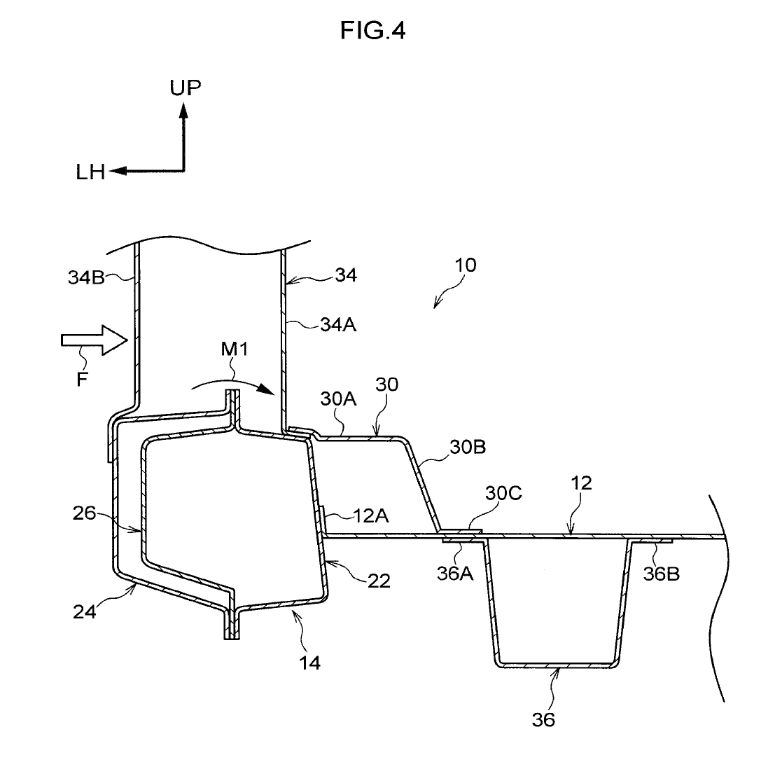

As illustrated in FIG. 4, when the center pillar 34 is input with collision load F in the event of a side-on collision of the vehicle, some of the collision load F is transmitted to the rocker 14, and moment M1 acts in the rocker 14 in a direction to collapse the rocker 14 toward the vehicle cabin inside (vehicle width direction inside). In the present exemplary embodiment, the sub-rocker 30 is disposed between the rocker 14 and the floor panel 12, and the sub-rocker 30 couples the rocker 14 and the floor panel 12 together. Some of collision load input to the rocker 14 is therefore transmitted through the sub-rocker 30 to the floor cross member 28 (see FIG. 2). Some of the remainder of the collision load is transmitted through the rocker inner panel 22 and the sub-rocker 30 to the floor panel 12.

As illustrated in FIG. 2, the sub-rocker 30 is formed longer in the vehicle front-rear direction than the floor cross member 28. This thereby enables the collision load acting in the rocker 14 to be borne over a wider range in the vehicle front-rear direction than in a configuration in which the floor cross member 28 is joined directly to the rocker 14. The moment M1 acting in the rocker 14 can accordingly be suppressed. Namely, collapse of the rocker 14 toward the vehicle cabin inside, and folding of the floor cross member 28, can be effectively suppressed. Moreover, some of the collision load is transmitted through the floor cross member 28 to the tunnel section 16.

As illustrated in FIG. 4, in the present exemplary embodiment three layers of the flange 30C of the sub-rocker 30, the floor panel 12, and the outside flange 36A of the under reinforcement 36 are all welded together with each other. Namely, the sub-rocker 30 and the floor panel 12 are joined together at the position where the under reinforcement 36 and the floor panel 12 are joined together. This thereby enables some of the collision load input the sub-rocker 30 to be transmitted to the under reinforcement 36, enabling the collision load in a side-on collision to be distributed. Concentration of collision load in the floor cross member 28 can accordingly be suppressed, enabling folding of the floor cross member 28 to be suppressed.

As illustrated in FIG. 3, in the present exemplary embodiment, the sub-tunnel section 32 that couples the tunnel section 16 together with the inside end portion 28C of the floor cross member 28 is provided above the floor panel 12 at the vehicle width direction outside of the tunnel section 16. Some of the collision load input to the floor cross member 28 through the sub-rocker 30 in a side-on collision is accordingly transmitted through the sub-tunnel section 32 to the tunnel section 16.

The sub-tunnel section 32 is formed longer in the vehicle front-rear direction than the floor cross member 28, such that collision load from the floor cross member 28 toward the sub-tunnel section 32 is distributed when transmitted to the tunnel section 16. This thereby enables collision load to be suppressed from being concentrated at a join portion between the floor cross member 28 and the tunnel section 16. Namely, the floor cross member 28 can be suppressed from breaking at a join portion between the floor cross member 28 and the left side face 16B of the tunnel section 16. Due to configuring each of the sub-rocker 30, the under reinforcement 36, and the sub-tunnel section 32 with closed cross-section structures in the present exemplary embodiment, rigidity can be increased in comparison to cases configured with open cross-sections.

In the present exemplary embodiment, as illustrated in FIG. 2, the under reinforcement 36 is disposed at an angle toward the vehicle width direction outside on progression from the vehicle front toward the vehicle rear in plan view. The under reinforcement 36 is therefore positioned further to the vehicle width direction outside at a portion where the sub-rocker 30 is disposed, than at a front end portion of the floor panel 12. A structure that transmits collision load to the under reinforcement 36 can accordingly be obtained without making the sub-rocker 30 unnecessarily long in the vehicle width direction. Namely, a broad space can be secured above the floor panel 12, even when the sub-rocker 30 is provided.

In the present exemplary embodiment, the three layers of the flange 30C of the sub-rocker 30, the floor panel 12, and the outside flange 36A of the under reinforcement 36 are all joined together with each other by spot welding or the like; however there is no limitation thereto, and they may be welded separately. Namely, in FIG. 3, the under reinforcement 36 and the floor panel 12 may be spot welded together first, and the sub-rocker 30 and the floor panel 12 spot welded together afterwards. Such cases still enable some of the collision load input to the sub-rocker 30 to be transmitted to the under reinforcement 36. Moreover, the three layers of the flange 30C of the sub-rocker 30, the floor panel 12, and the outside flange 36A of the under reinforcement 36 may all be fastened together with each other using nuts and bolts.

If collision load is not to be transmitted from the sub-rocker 30 to the under reinforcement 36, the position where the sub-rocker 30 is joined to the floor panel 12 may be set at a separate position from the join portion between the under reinforcement 36 and the floor panel 12. In such cases, for example, the under reinforcement 36 may be provided substantially along a straight line in the vehicle front-rear direction in plan view. A configuration in which the sub rocker 30 and the under reinforcement 36 are joined to the floor panel 12 at separate positions is not encompassed by the second aspect of the present disclosure; however it is encompassed by the first aspect.

In the present exemplary embodiment, the inside end portion 28C of the floor cross member 28 is coupled to the tunnel section 16 through the sub-tunnel section 32; however there is no limitation thereto, and the floor cross member 28 may be connected to the tunnel section 16 directly. Such a configuration is not encompassed by the fourth aspect of the present disclosure; however it is encompassed by the first aspect.

The length of the sub-rocker 30 may be made even longer in the vehicle front-rear direction. In the present exemplary embodiment, the length of the sub-rocker 30 in the vehicle front-rear direction is formed shorter than the length of the floor panel 12 in the vehicle front-rear direction; however there is no limitation thereto, and the length of the sub-rocker 30 in the vehicle front-rear direction may be made substantially the same as the length of the floor panel 12 in the vehicle front-rear direction. Namely, the sub-rocker 30 may extend along the rocker 14 from the dash panel 18 as far as the rear cross member 20.

In the present exemplary embodiment, a single pair of the left and right floor cross members 28 is provided above the floor panel 12; however more of the floor cross members 28 may be provided. For example, second floor cross members may be provided to the vehicle rear of the respective floor cross members 28. In such cases, vehicle width direction outside end portions of the second floor cross members may be joined to second sub-rockers. Moreover, the sub-rockers 30 may be extended in the vehicle front-rear direction, and joined to both the floor cross members 28 and the second floor cross members.

The shape of the sub-rocker 30 is not particularly limited, as long as the sub-rocker 30 is formed longer than the vehicle front-rear direction length of the floor cross member 28. For example, the sub-rocker 30 may be formed with a polygonal shape, or may be formed in a substantially triangular shape, in plan view.

### Second Exemplary Embodiment

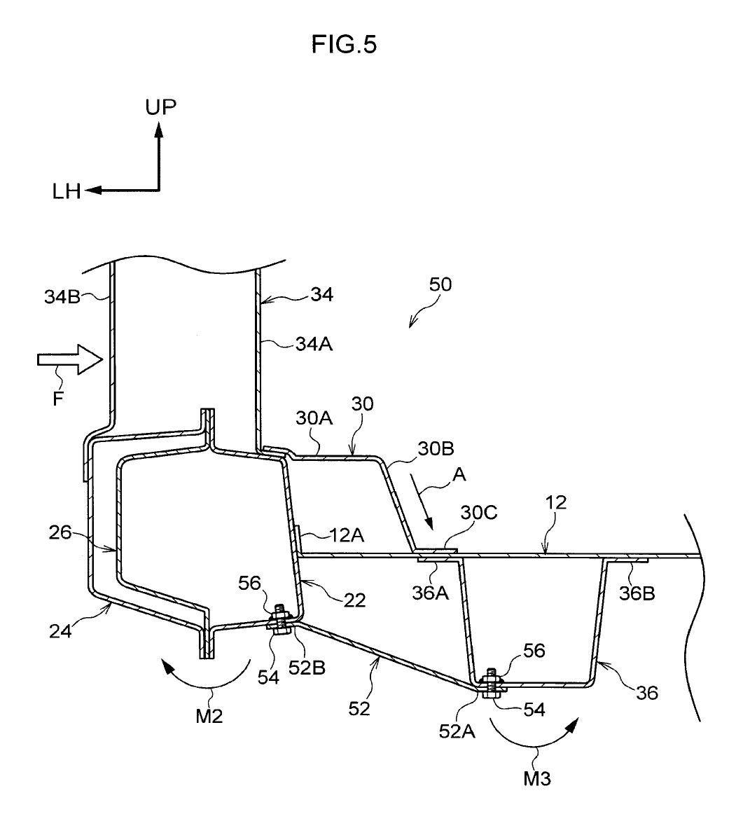

Next, explanation follows regarding a vehicle lower section structure according to a second exemplary embodiment of the present disclosure, with reference to FIG. 5. In the present exemplary embodiment, the rocker 14 and the under reinforcement 36 are coupled together by a brace 52. Configurations similar to those of the first exemplary embodiment arc allocated the same reference numerals, and explanation thereof is omitted as appropriate.

As illustrated in FIG. 5, in a vehicle lower section 50 of the vehicle applied with the vehicle lower section structure of the present exemplary embodiment, the rocker 14 and the floor panel 12 are coupled together by the sub-rocker 30. The under reinforcement 36 is joined to the lower face of the floor panel 12, and the flange 30C of the sub-rocker 30 and the floor panel 12 are joined together at the position where the outside flange 36A of the under reinforcement 36 is joined to the floor panel 12.

The under reinforcement 36 and a vehicle lower side end portion of the rocker 14 are coupled together by the brace 52, serving as a coupling member. The brace 52 is a substantially rectangular plate shaped metal member, and is inclined toward the vehicle lower side on progression from the rocker 14 toward the under reinforcement 36.

An inside end portion 52A on the vehicle width direction inside of the brace 52 is bent to follow a bottom face of the under reinforcement 36, and is fastened to the bottom face of the under reinforcement 36 by bolts 54 and nuts 56. An outside end portion 52B on the vehicle width direction outside of the brace 52 is bent to follow a bottom face of the rocker inner panel 22, and is fastened to the bottom face of the rocker inner panel 22 by bolts 54 and nuts 56.

In the present exemplary embodiment, the brace 52 is fastened to the under reinforcement 36, and the brace 52 is fastened to the rocker 14, using the bolts 54 and the nuts 56; however there is no limitation thereto, and the brace may be joined by another method. For example, joining may be made by welding using spot welding or the like. The shape, size, and thickness of the brace 52 are not particularly limited, and may be modified as appropriate depending on the required tensile strength and the like.

### Operation

According to the present exemplary embodiment, when the center pillar 34 is input with collision load F in the event of a side-on collision of the vehicle, some of the collision load F is transmitted to the rocker 14, and moment M2 acts in the rocker 14 to collapse the rocker 14 toward the vehicle cabin inside (vehicle width direction inside). Since part of the collision load F is transmitted from the rocker 14, through the sub-rocker 30 and into the under reinforcement 36, load at the vehicle lower side acts in the outside flange 36A of the under reinforcement 36, as illustrated by the arrow A in FIG. 5. The vehicle width direction outside of the under reinforcement 36 is accordingly pushed, and moment M3 acts in the under reinforcement 36 toward the opposite direction to the rocker 14.

As described above, the rocker 14 and the under reinforcement 36 attempt to rotate in opposite directions to each other with respect to the floor panel 12. Since the vehicle lower side of the rocker 14 and the under reinforcement 36 are coupled together by the brace 52, tensile force acts in the brace 52, enabling rotation of the rocker 14 and the under reinforcement 36 to be suppressed. This thereby enables collapse of the rocker 14 toward the vehicle cabin inside, and collapse of the under reinforcement 36, to be effectively suppressed. Other operation is similar to that of the first exemplary embodiment.

In the present exemplary embodiment, the substantially rectangular plate shaped brace 52 is employed as a coupling member; however there is no limitation thereto, and the rocker 14 and the under reinforcement 36 may be coupled together using coupling members of other structures. For example, a substantially tube shaped coupling member, or substantially circular columnar shaped coupling member, may be employed. The brace 52 may be fastened to plural locations on the rocker 14 and the under reinforcement 36 respectively. Plural braces 52 may also be provided along the vehicle front-rear direction.

Explanation has been given regarding vehicle lower section structures according to the first exemplary embodiment and the second exemplary embodiment of the present disclosure; however various configurations may obviously be implemented within a range not departing from the spirit of the present disclosure.

What is claimed is:

1. A vehicle lower section structure comprising:
a rocker disposed at a vehicle width direction outside of a floor panel, and extending in a vehicle front-rear direction;
a floor cross member disposed above the floor panel, and extending in a vehicle width direction; and
a sub-rocker that is disposed above the floor panel between the rocker and the floor cross member, that couples the rocker to a vehicle width direction outside end portion of the floor cross member, and that is formed with a longer length than the floor cross member in the vehicle front-rear direction.

2. The vehicle lower section structure of claim 1, wherein:
an under reinforcement that extends in the vehicle front-rear direction, that includes flanges on both vehicle width direction sides, and that has a hat shaped cross-section open toward the vehicle upper side, is joined to a vehicle lower side face of the floor panel; and
the sub-rocker is joined to the floor panel at a position at which the flange on the vehicle width direction outside of the under reinforcement is joined to the floor panel.

3. The vehicle lower section structure of claim 2, wherein the under reinforcement is coupled to a vehicle lower side end portion of the rocker by a coupling member.

4. The vehicle lower section structure of claim 1, wherein:
a tunnel section extends along the vehicle front-rear direction at a vehicle width direction central portion of the floor panel; and
a sub-tunnel section that couples the tunnel section to a vehicle width direction inside end portion of the floor cross member, and that is formed with a longer length than the floor cross member in the vehicle front-rear direction, is provided above the floor panel at the vehicle width direction outside of the tunnel section.
